(19) United States
(12) Patent Application Publication
(10) Pub. No.: US 2026/0162224 A1
(43) Pub. Date: Jun. 11, 2026

(54) INFORMATION PROCESSING DEVICE AND CONTROL METHOD FOR INFORMATION PROCESSING DEVICE

(71) Applicant: CANON KABUSHIKI KAISHA, Tokyo (JP)

(72) Inventors: Yoshikazu KAWAI, Tokyo (JP); Shuhei IINO, Kanagawa (JP); Shinya OMORI, Tokyo (JP)

(21) Appl. No.: 19/377,347

(22) Filed: Nov. 3, 2025

(30) Foreign Application Priority Data
Dec. 11, 2024 (JP) 2024-216324

(51) Int. Cl. G06T 5/50; G06T 19/00

(52) U.S. Cl. CPC G06T 5/50; G06T 19/006; G06T 2207/20221

(57) ABSTRACT

An information processing device, connected to an imaging device, includes: a processor; and a memory storing a program which, when executed by the processor, causes the information processing device to: acquire a first image in which a space is imaged according to a viewpoint of a user; acquire a second image in which the space is imaged by the imaging device; and generate a composite image in which the second image and a third image are combined with each other, wherein in a first case where a distance between a head of the user and the imaging device is larger than a threshold, the third image is the first image, and in a second case where the distance is equal to or less than the threshold, the second image is arranged closer to a center of the composite image than in the first case.

### BACKGROUND

### Field of the Technology

The present disclosure relates to an information processing device and a control method for the information processing device.

### Description of the Related Art

A virtual reality (VR) technology is known as a technology with which a virtual space can be experienced. In addition, a so-called mixed reality (MR) technology (technology of mixed reality feeling) is known as a technology for seamlessly fusing a real space and a virtual space in real time. As a device with which such a technology can be experienced, for example, a head-mounting type device represented by a head mounted display (HMD) is used.

Japanese Patent Laid-Open No. 2005-346468 describes a method for determining which one of a virtual object and a real object is to be displayed based on whether or not a distance between a position of a viewpoint and a position of the virtual object exceeds a set threshold when the virtual object and the real object overlap each other.

In order to photograph a space (MR space) including a real space and a virtual object at an arbitrary angle of view, a screenshot function of an HMD equipped with an MR technology is used. In this case, the HMD has a limited photographing function due to a weight relationship or the like, and thus the quality of an image that can be photographed is not high as compared with an imaging device that captures an image of a real space having high photographing performance.

Here, in order to photograph a high-quality MR image, it has been required to photograph the MR space while confirming a photographing angle of view and a preview image from the viewpoint of an external imaging device with high photographing performance using the external imaging device. However, photographing with an external imaging device while viewing the MR space in a state where the HMD is worn has not been considered so far. When the conventional photographing method of the imaging device in which the HMD is not worn is applied to the state in which the HMD is worn, the operability of the imaging device is reduced by the HMD, and there is a case where the photographing cannot be performed in a concentrated manner.

### SUMMARY

The present disclosure is directed to a technology for generating an image that assists a user so that photographing can be performed in a concentrated manner in a case where an MR space is photographed by an imaging device.

One embodiment of the present disclosure is an information processing device communicably connected to an imaging device, the information processing device including: a processor; and a memory storing a program which, when executed by the processor, causes the information processing device to: execute first acquisition processing of acquiring a first image in which a space is imaged according to a viewpoint of a user; execute second acquisition processing of acquiring a second image in which the space is imaged by the imaging device; and execute generation processing of generating a composite image in which the second image and a third image are combined with each other, wherein in a first case where a distance between a head of the user and the imaging device is larger than a threshold, the third image is the first image, and wherein in the generation processing, in a second case where the distance between the head of the user and the imaging device is equal to or less than the threshold, the second image is arranged closer to a center of the composite image than in the first case.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram for explaining a configuration of a system according to a first embodiment.

FIGS. 2A and 2B are external views of a camera according to the first embodiment.

FIG. 3 is an internal configuration diagram of the camera according to the first embodiment.

FIG. 4 is an internal configuration diagram of an HMD and the like according to the first embodiment.

FIG. 5 is a diagram illustrating an MR space according to the first embodiment.

FIG. 6 is a diagram illustrating a display example of the HMD according to the first embodiment.

FIG. 7 is a flowchart of live view processing of the camera according to the first embodiment.

FIG. 8 is a flowchart of live view processing of a PC according to the first embodiment.

FIG. 9 is a flowchart of UI display processing of the PC according to the first embodiment.

FIG. 10 is a flowchart of live view processing of a camera according to a second embodiment.

FIG. 11 is a flowchart of UI display processing of a PC according to the second embodiment.

FIGS. 12A and 12B are diagrams illustrating a composite image according to the first embodiment.

FIGS. 13A and 13B are diagrams illustrating a composite image according to the first embodiment.

### DESCRIPTION OF THE EMBODIMENTS

Hereinafter, embodiments will be described in detail with reference to the accompanying drawings. Note that, the following embodiments do not limit the disclosure according to the claims. Although a plurality of features are described in the embodiment, not all of the plurality of features are essential, and the plurality of features may be freely combined. Furthermore, in the accompanying drawings, the same or similar configurations are denoted by the same reference numerals, and redundant description will be omitted.

### First Embodiment

### Configuration of Entire System

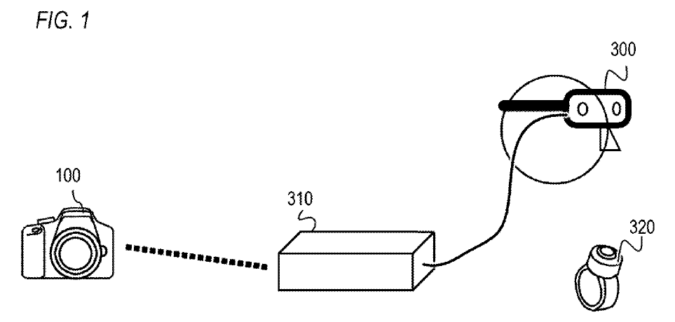

An example of a configuration of the entire system according to the first embodiment will be described with reference to FIG. 1. An information processing system 1 includes a camera 100, an HMD 300, a personal computer (PC) 310, and a controller 320.

The camera 100 is connected to the PC 310 in a wired or wireless communicable state. The camera 100 transmits and receives various data (live view image data, photographed image data, and the like). Note that, for example, instead of the camera 100, an imaging device (a smartphone, a tablet terminal, or the like) capable of realizing the functions described below may be used. Note that the camera 100 may communicate with not only the PC 310, but also the HMD 300.

The HMD 300 is a display device (head-mounting type electronic device) that can be mounted on the head of the user. The HMD 300 displays a composite image in which “a captured image obtained by imaging a range in front of the user by the HMD 300” and “content such as CG in a form corresponding to the position and orientation of the HMD 300” are combined.

The PC 310 is an information processing device that controls the HMD 300. The PC 310 is connected to the HMD 300 in a wired manner such as a USB cable or in a wireless manner such as Bluetooth (trademark) or Wireless Fidelity (Wi-Fi) (trademark). For example, the PC 310 generates a composite image by combining the captured image and the CG, and transmits the composite image to the HMD 300. In this case, when receiving the live view image or the photographed image from the camera 100, the PC 310 generates a composite image in which the received image and the CG in a form corresponding to the position and orientation of the camera 100 are combined. The PC 310 transmits the composite image to the HMD 300.

Note that a smartphone or a tablet terminal may be used instead of the PC 310. Furthermore, each configuration of the PC 310 may be included in the HMD 300. Note that, in the first embodiment, an example in which the PC 310 and the camera 100 are wirelessly connected is shown, but the PC 310 and the camera 100 may be connected by wire.

The controller 320 performs various controls of the HMD 300. In a case where the PC 310 is in a specific control mode, when a user operation is performed on the controller 320, the HMD 300 is controlled according to the user operation. As illustrated in FIG. 1, the controller 320 is an operation member having a “ring shape that can be worn on and supported by a user's finger” or a “hand-held shape held by a hand”. In addition, the controller 320 includes physical buttons for performing a determination operation and a selection operation displayed on the display.

The controller 320 performs wireless communication by Bluetooth with PC 310. Note that the controller 320 may communicate with not only the PC 310, but the HMD 300. The user can change the instruction position on the display according to the movement of the controller 320 by moving the controller 320. The instruction position may be expressed by a point, or the point of the instruction position and the controller may be connected by a straight line (line segment) or a dotted line and expressed by a virtual ray (ray). The user can perform a menu determination operation or a menu selection operation by pressing a physical button.

Note that the shape of the controller 320 is a ring type or a handheld type. However, the controller 320 may have any shape as long as it can be supported by a finger, a hand, or an arm. In addition, although the buttons of the controller 320 are physical buttons, it is sufficient that the buttons can be operated like a track pad, a touch panel, a wheel, or a track ball. Further, the controller 320 may be capable of receiving a slide operation, a flick operation, and a touch operation in addition to button pressing. Note that the controller 320 may be attachable to at least one of a finger, a hand, or an arm. Note that the controller 320 may be attached to an object held by hand, and position information and orientation information of the attached position may be acquired from the sensor. Examples of such an object include an object imitating a tool.

### External Configuration of Digital Camera

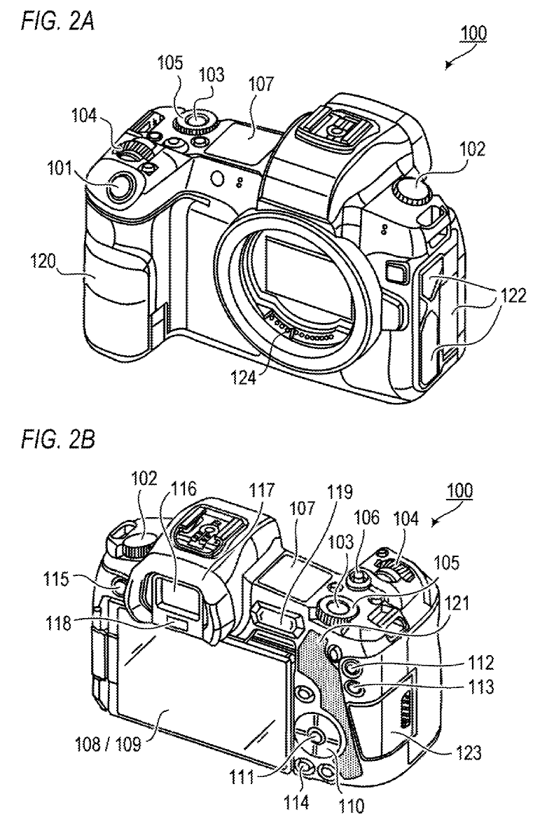

FIGS. 2A and 2B are diagrams illustrating an example of an external configuration of a camera 100 that is an imaging device. FIG. 2A is a perspective view of the camera 100 as viewed from the front. FIG. 2B is a perspective view of the camera 100 as viewed from the back.

The camera 100 includes, on an upper surface thereof, a shutter button 101, a power switch 102, a mode selector switch 103, a main electronic dial 104, a sub-electronic dial 105, a moving image button 106, and an outside viewfinder display unit 107.

The shutter button 101 is an operation unit for performing a photographing preparation or a photographing instruction. The power switch 102 is an operation unit for switching on or off of a power supply of the camera 100. The mode selector switch 103 is an operation unit for switching various modes.

The main electronic dial 104 is a rotary operation unit for changing setting values such as a shutter speed and an aperture value. The sub-electronic dial 105 is a rotary operation unit for moving a selection frame (cursor) and feeding images.

The moving image button 106 is an operation unit for providing an instruction to start or stop moving image photographing (recording). The outside viewfinder display unit 107 displays various setting values such as a shutter speed and an aperture value.

In addition, the camera 100 includes a display unit 108, a touch panel 109, a direction key 110, a SET button 111, an AE lock button 112, an enlargement button 113, a reproduction button 114, a menu button 115, an eyepiece part 116, an eyepiece detection unit 118, and a touch bar 119 on the back surface.

The display unit 108 displays images and various types of information. The touch panel 109 is an operation unit for detecting a touch operation on a display surface (touch operation surface) of the display unit 108.

The direction key 110 is an operation unit configured with keys that can be pressed up, down, left, and right (four direction keys). The camera 100 can be controlled according to the pressed position of the direction key 110. The SET button 111 is an operation unit to be pressed mainly when a selected item is determined.

The AE lock button 112 is an operation unit to be pressed when an exposed state is fixed in a photographing standby state.

The enlargement button 113 is an operation unit for switching on or off of an enlargement mode in live view display (LV display) of a photographing mode. In a case where the enlargement mode is on, when the main electronic dial 104 is operated, the live view image (LV image) is enlarged or reduced. The enlargement button 113 is used to enlarge the reproduced image or increase the enlargement ratio in the reproduction mode.

The reproduction button 114 is an operation unit for switching the photographing mode and the reproduction mode. In the photographing mode, when the reproduction button 114 is pressed, the mode shifts to the reproduction mode, and the latest image among the images recorded in the recording medium 227 described later is displayed on the display unit 108.

The menu button 115 is an operation unit to be pressed for displaying a menu screen, which enables various settings, on the display unit 108. A user can intuitively perform various settings by using the menu screen displayed on the display unit 108, the direction key 110, and the SET button 111.

The eyepiece part 116 is a part for bringing an eye closer to (in contact with) the eyepiece finder (looking-in type finder) 117. The user can visually recognize the video displayed on an electronic view finder (EVF) 217 through the eyepiece part 116.

The eyepiece detection unit 118 is a sensor that detects whether or not the user is in contact with the eyepiece part 116.

The touch bar 119 is a linear touch operation unit (line touch sensor) capable of receiving a touch operation. The touch bar 119 is disposed “at a position capable of a touch operation (touchable) with the thumb of the right hand in a state where a grip portion 120 is gripped with the right hand (a state gripped with the little finger, the ring finger, and the middle finger of the right hand)” such that the shutter button 101 can be pressed by the index finger of the right hand. That is, the touch bar 119 can be operated in a state in which an eye is brought into contact with the eyepiece part 116 to look into the eyepiece finder 117 and the camera is held so that the shutter button 101 can be pressed at any time (photographing posture). The touch bar 119 can receive a tapping operation on the touch bar 119 (an operation of touching and releasing the touch bar without moving within a predetermined period of time), a sliding operation to the left or right (an operation of touching the touch bar and then moving the touch position while keeping the touch), and the like. The touch bar 119 is an operation unit that is different from the touch panel 109 and does not have a display function. The touch bar 119 of the present embodiment is a multi-function bar and functions as, for example, an M-Fn bar.

In addition, the camera 100 has a grip portion 120, a thumb rest portion 121, a terminal cover 122, a lid 123, a communication terminal 124, and the like.

The grip portion 120 is a holding portion formed in a shape easy for the user to grip with the right hand when the user holds the camera 100. The shutter button 101 and the main electronic dial 104 are arranged at positions capable of operation with the index finger of the right hand in a state where the camera 100 is held with the grip portion 120 gripped with the little finger, the ring finger, and the middle finger of the right hand. In the same state, the sub-electronic dial 105 and the touch bar 119 are arranged at positions capable of being operated by the thumb of the right hand.

The thumb rest portion 121 (thumb standby position) is a grip portion provided on the back side of the camera 100 at a place where the thumb of the right hand gripping the grip portion 120 is easily placed in a state where no operation unit is operated. The thumb rest portion 121 is configured with a rubber member for enhancing holding power (gripping feeling).

The terminal cover 122 protects a connector such as a connection cable for connecting the camera 100 to an external device. The lid 123 closes a slot for storing the recording medium 227 to protect the recording medium 227 and the slot.

The communication terminal 124 is a terminal for communicating with a lens unit 200.

### Internal Configuration of Digital Camera

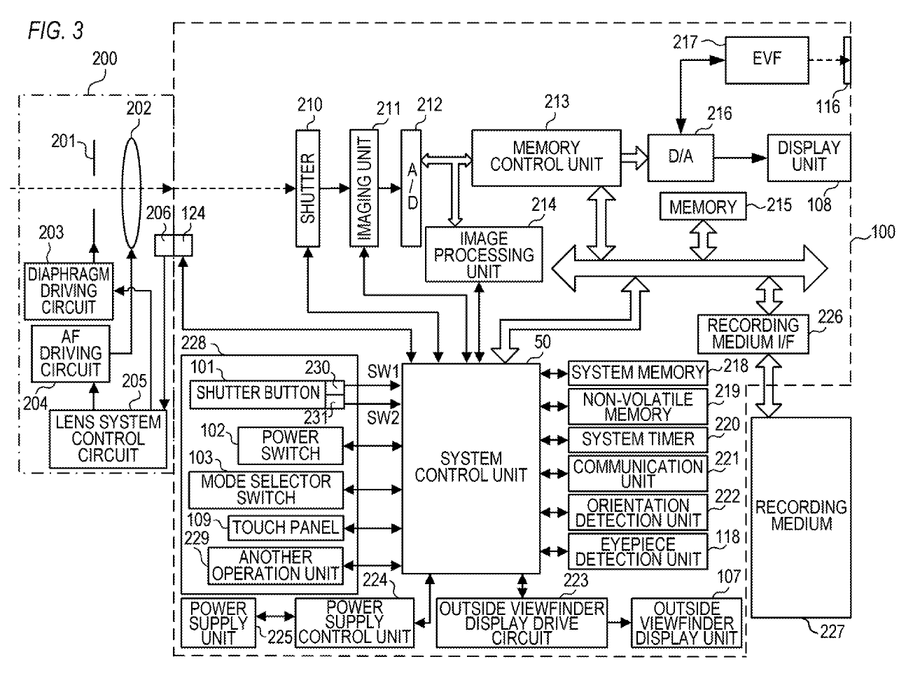

FIG. 3 is a view illustrating an example of an internal configuration of the camera 100. In FIG. 3, the same components as those in FIGS. 2A and 2B are denoted by the same reference numerals, and the description thereof will be appropriately omitted. The lens unit 200 is attached to the camera 100.

First, the lens unit 200 will be described. The lens unit 200 is a kind of interchangeable lens detachable from the camera 100. The lens unit 200 is a single lens, an example of a typical lens. The lens unit 200 includes a diaphragm 201, a lens 202, a diaphragm driving circuit 203, an autofocus (AF) driving circuit 204, a lens system control circuit 205, a communication terminal 206, and the like.

The opening diameter of the diaphragm 201 is adjustable. The lens 202 is configured with a plurality of lenses. The diaphragm driving circuit 203 adjusts a quantity of light by controlling the opening diameter of the diaphragm 201. The AF driving circuit 204 adjusts the focus by driving the lens 202.

The lens system control circuit 205 controls the diaphragm driving circuit 203, the AF driving circuit 204, and the like on the basis of an instruction from the system control unit 50. The lens system control circuit 205 controls the diaphragm 201 via the diaphragm driving circuit 203. Further, the lens system control circuit 205 adjusts the focus by changing the position of the lens 202 via the AF driving circuit 204. The lens system control circuit 205 can communicate with the camera 100. Specifically, communication is performed via the communication terminal 206 of the lens unit 200 and the communication terminal 124 of the camera 100. The communication terminal 206 is a terminal for the lens unit 200 to communicate with the camera 100 side.

Next, the camera 100 is described. The camera 100 includes a shutter 210, an imaging unit 211, an A/D converter 212, a memory control unit 213, an image processing unit 214, a memory 215, a D/A converter 216, the EVF 217, the display unit 108, and the system control unit 50.

The shutter 210 is a focal plane shutter that can freely control an exposure time of the imaging unit 211 based on an instruction of the system control unit 50.

The imaging unit 211 is an imaging element (image sensor) configured with a CCD, a CMOS element, or the like that converts an optical image into an electrical signal. The imaging unit 211 may include an imaging-surface phase-difference sensor for outputting defocus-amount information to the system control unit 50.

The A/D converter 212 converts an analog signal output from the imaging unit 211 into a digital signal.

The image processing unit 214 performs predetermined processing (pixel interpolation, resizing processing such as reduction, color conversion processing, and the like) on data from the A/D converter 212 or data from the memory control unit 213. In addition, the image processing unit 214 performs predetermined calculation processing using the photographed image data, and the system control unit 50 performs exposure control and distance measurement control on the basis of the obtained calculation result. By this processing, through-the-lens (TTL)-type AF processing, auto exposure (AE) processing, EF (flash pre-flash) processing, and the like are performed. Furthermore, the image processing unit 214 performs predetermined calculation processing using the photographed image data, and performs TTL automatic white balance (AWB) processing on the basis of the obtained calculation result. The image data from the A/D converter 212 is written into the memory 215 via the image processing unit 214 and the memory control unit 213. Alternatively, the image data from the A/D converter 212 is written into the memory 215 via the memory control unit 213 without the intervention of the image processing unit 214.

The memory 215 stores “Image data obtained by the imaging unit 211 and converted into digital data by the A/D converter 212” and “image data to be displayed on the display unit 108 or the EVF 217”. The memory 215 has a sufficient storage capacity to store a predetermined number of still images, a moving image for a predetermined time, and sound. The memory 215 also serves as a memory (video memory) for image display.

The D/A converter 216 converts data for image display stored in the memory 215 into an analog signal, and supplies the analog signal to the display unit 108 and the EVF217. Therefore, the image data for display written in the memory 215 is displayed on the display unit 108 and the EVF 217 via the D/A converter 216. The display unit 108 and the EVF 217 provide display in response to the analog signal from the D/A converter 216. The display unit 108 and the EVF 217 is, for example, a display such as an LCD or an organic EL. The digital signal A/D converted by the A/D converter 212 and accumulated in the memory 215 is converted into an analog signal by the D/A converter 216. By sequentially transferring the analog signal to the display unit 108 and the EVF 217, live view display of displaying an image representing a real-time space is performed.

The system control unit 50 is a control unit including at least one processor and/or at least one circuit. That is, the system control unit 50 may be a processor, a circuit, or a combination of a processor and a circuit. The system control unit 50 controls the entire camera 100. The system control unit 50 executes a program recorded in the non-volatile memory 219 to implement each processing of a flowchart to be described later. The system control unit 50 also performs display control by controlling the memory 215, the D/A converter 216, the display unit 108, the EVF 217, and the like.

In addition, the camera 100 includes a system memory 218, a non-volatile memory 219, a system timer 220, a communication unit 221, an orientation detection unit 222, and an eyepiece detection unit 118.

For example, a RAM is used as the system memory 218. In the system memory 218, a “constant and variable for operation of the system control unit 50”, a “program read from the non-volatile memory 219”, and the like are developed.

The non-volatile memory 219 is an electrically erasable and recordable memory. For example, an EEPROM is used as the non-volatile memory 219. In the non-volatile memory 219, constants, programs, and the like for operation of the system control unit 50 are recorded. The program here is a program for executing processing of a flowchart to be described later.

The system timer 220 is a clocking unit that measures a time used for various types of control and a time of a built-in clock. The communication unit 221 transmits and receives a video signal or an audio signal to and from an external device connected by wireless or by a wired cable.

The communication unit 221 can also be connected to a wireless local area network (LAN) and the Internet. Furthermore, the communication unit 221 can also communicate with an external device by Bluetooth (trademark) and Bluetooth Low Energy. The communication unit 221 can transmit an image (including a live image) photographed by the imaging unit 211 and an image recorded on the recording medium 227. Furthermore, the communication unit 221 can receive image data and other various types of information from an external device.

The orientation detection unit 222 detects the orientation of the camera 100 with respect to the gravity direction. “Whether the image photographed by the imaging unit 211 is an image photographed with the camera 100 held horizontally or vertically” can be determined based on the orientation detected by the orientation detection unit 222. The system control unit 50 can add orientation information corresponding to the orientation detected by the orientation detection unit 222 to the image file of the image photographed by the imaging unit 211, or rotate and record the image. For example, an acceleration sensor or a gyro sensor can be used for the orientation detection unit 222. It is also possible to detect the movement of the camera 100 (whether or not it is panning, tilting, lifting, stationary, or the like) by using the orientation detection unit 222.

The eyepiece detection unit 118 can detect approach of an object to the eyepiece part 116 of the “eyepiece finder 117 incorporating the EVF 217”. For example, an infrared proximity sensor can be used for the eyepiece detection unit 118. In a case where an object approaches the eyepiece part 116, infrared rays projected from the light projecting part of the eyepiece detection unit 118 are reflected by the object and received by the light receiving part of the infrared proximity sensor. The distance from the eyepiece part 116 to the object can be determined by the amount of received infrared light (= sensor value). In this manner, the eyepiece detection unit 118 performs the eyepiece detection of detecting the proximity distance of the object to the eyepiece part 116. The eyepiece detection unit 118 is an eyepiece detection sensor that detects approach (contact with eye) and separation (separation from eye) of an eye (object) to and from the eyepiece part 116 of the eyepiece finder 117. In a case where an object approaching within a predetermined distance with respect to the eyepiece part 116 from the non-eye contacting state (non-approaching state) is detected, it is detected that an eye is in contact. On the other hand, in a case where the object whose approach has been detected is separated from the eye contacting state (approaching state) by a predetermined distance or more, it is detected that the eye is separated. The threshold for detecting the eye contact and the threshold for detecting the eye separation may be different, for example, by providing hysteresis or the like. In addition, after the eye contact is detected, the eye contacting state is assumed until the eye separation is detected. After the eye separation is detected, the non-eye contacting state is assumed until the eye contact is detected.

The system control unit 50 switches between display (display state) and non-display (non-display state) of each of the display unit 108 and the EVF 217 in accordance with the state detected by the eyepiece detection unit 118. Specifically, at least in the photographing standby state and when the switching setting of the display destination is the automatic switching, the system control unit 50 turns on the display with the display destination as the display unit 108 during the non-eye contact, and hides the EVF 217. In addition, the system control unit 50 turns on the display with the EVF 217 as the display destination and hides the display unit 108 during the eye contact. Note that the eyepiece detection unit 118 is not limited to the infrared proximity sensor, and other sensors may be used as long as a state that can be regarded as the eye contact can be detected.

Furthermore, the camera 100 includes an outside viewfinder display unit 107, an outside viewfinder display drive circuit 223, a power supply control unit 224, a power supply unit 225, a recording medium I/F 226, an operation unit 228, and the like.

The outside viewfinder display unit 107 displays various setting values (shutter speed, aperture value, and the like) of the camera 100 via the outside viewfinder display drive circuit 223.

The power supply control unit 224 includes a battery detection circuit, a DC-DC converter, a switch circuit that switches a block to be energized, and the like. The power supply control unit 224 detects whether or not the battery is attached, the type of the battery, the remaining battery level, and the like. Furthermore, the power supply control unit 224 controls the DC-DC converter on the basis of the detection result and the instruction of the system control unit 50, and supplies a necessary voltage to each unit (including the recording medium 227) for a necessary period.

The power supply unit 225 is a primary battery (an alkaline battery, a lithium battery, or the like), a secondary battery (NiCd battery, NiMH battery, Li battery, or the like), an AC adapter, or the like.

The recording medium I/F 226 is an interface with the recording medium 227. The recording medium 227 is a memory card or the like for recording a photographed image. The recording medium 227 is configured with a semiconductor memory, a magnetic disk, or the like.

The recording medium 227 may be detachable from the camera 100 or may be built in the camera 100.

The operation unit 228 is an input unit that receives an operation from the user (user operation). The operation unit 228 is used to input various instructions to the system control unit 50. The operation unit 228 includes a shutter button 101, a power switch 102, a mode selector switch 103, a touch panel 109, another operation unit 229, and the like.

The another operation unit 229 includes a main electronic dial 104, a sub-electronic dial 105, a moving image button 106, a direction key 110, a SET button 111, an AE lock button 112, an enlargement button 113, a reproduction button 114, a menu button 115, a touch bar 119, and the like.

The shutter button 101 includes a first shutter switch 230 and a second shutter switch 231.

The first shutter switch 230 is turned on in the middle of the operation of the shutter button 101, that is, by so-called half-pressing (photographing preparation instruction), and generates a first shutter switch signal SW1. Upon generation of the first shutter switch signal SW1, the system control unit 50 starts photographing preparation processing (AF processing, AE processing, AWB processing, EF processing, and the like).

The second shutter switch 231 is turned on at the completion of the operation of the shutter button 101 that is, by so-called full-pressing (photographing instruction) and generates a second shutter switch signal SW2. The system control unit 50 starts a series of photographing processing (from reading of a signal from the imaging unit 211 to generation and writing of an image file including a photographed image onto the recording medium 227) by generation of the second shutter switch signal SW2.

The mode selector switch 103 switches the operation mode of the system control unit 50 to any one of a still image photographing mode, a moving image photographing mode, a reproduction mode, and the like. The mode included in the still image photographing mode includes an automatic photographing mode, an automatic scene determination mode, a manual mode, an aperture priority mode (Av mode), a shutter speed priority mode (Tv mode), a program AE mode (P mode), and the like. The mode included in the still image photographing mode includes various scenes mode, a custom mode, and the like that are photographing settings for each photographing scene. The user can directly switch the mode to any of the above-described photographing modes with the mode selector switch 103. Alternatively, the user can temporarily switch a screen to a list screen of the photographing modes with the mode selector switch 103 and then selectively switch the mode to any of the plurality of displayed modes using the operation unit 228. Similarly, the moving image photographing mode may include a plurality of modes.

The touch panel 109 is a touch sensor that detects various touch operations on a display surface of the display unit 108 (an operation surface of the touch panel 109). The touch panel 109 and the display unit 108 can be integrally configured. For example, the touch panel 109 is attached to an upper layer of the display surface of the display unit 108 such that a transmittance of light of the touch panel 109 does not hinder the display on the display unit 108. Furthermore, input coordinates on the touch panel 109 and display coordinates on the display surface of the display unit 108 are associated with each other, thereby configuring a graphical user interface (GUI) such that the user can directly operate a screen displayed on the display unit 108. For the touch panel 109, any of various methods such as a resistive film method, a capacitance method, a surface acoustic wave method, an infrared method, an electromagnetic induction method, an image recognition method, and an optical sensor method can be used. Depending on the methods, there are a method of detecting a touch based on contact with the touch panel 109 and a method of detecting a touch based on approach of a finger or a pen to the touch panel 109, but any method may be adopted.

The system control unit 50 can detect the following operations or states on the touch panel 109.

An operation in which a finger or a pen that has not touched the touch panel 109 newly touches the touch panel 109, that is, a start of the touch (hereinafter, referred to as Touch-Down).

A state in which the finger or the pen is in contact with the touch panel 109 (hereinafter referred to as Touch-On).

An operation in which the finger or the pen is moving while being in contact with the touch panel 109 (hereinafter referred to as Touch-Move).

An operation in which the finger or the pen that is in contact with the touch panel 109 is separated from (released from) the touch panel 109, that is, an end of the touch (hereinafter referred to as Touch-Up).

A state in which nothing is in contact with the touch panel 109 (hereinafter referred to as Touch-Off).

When Touch-Down is detected, Touch-On is detected at the same time. After Touch-Down, normally Touch-On is continuously detected unless Touch-Up is detected. Also, when Touch-Move is detected, Touch-On is detected at the same time. Even when Touch-On is detected, Touch-Move is not detected unless the touch position is moved. After Touch-Up of all the fingers and the pens that have touched the touch panel 109 is detected, the state transitions to Touch-Off.

These operations and states and the position coordinates of the finger or the pen that is in contact with the touch panel 109 are notified to the system control unit 50 through an internal bus. The system control unit 50 determines what kind of operation (touch operation) has been performed on the touch panel 109 on the basis of the notified information. With regard to Touch-Move, also a movement direction of the finger or the pen moving on the touch panel 109 can be determined for each of a vertical component and a horizontal component on the touch panel 109, based on change of the position coordinates. When Touch-Move for a predetermined distance or longer is detected, it is determined that a sliding operation is performed. An operation of quickly moving a finger by a certain distance while touching the touch panel 109 and releasing the finger is called flick. In other words, the flick is an operation in which the finger is quickly slid on the touch panel 109 so as to flick the touch panel 109. When it is detected that Touch-Move is performed at a predetermined speed or more for a predetermined distance or more and Touch-Up is detected as it is, it is determined that flicking has been performed (it can be determined that flicking has occurred following the sliding operation). Furthermore, a touch operation in which a plurality of places (for example, two points) are both touched (multi-touched) and the touch positions are brought close to each other is referred to as pinch-in, and a touch operation in which the touch positions are moved away from each other is referred to as pinch-out. The pinch-out and the pinch-in are collectively referred to as a pinching operation (or simply referred to as a pinch).

### Configuration of HMD

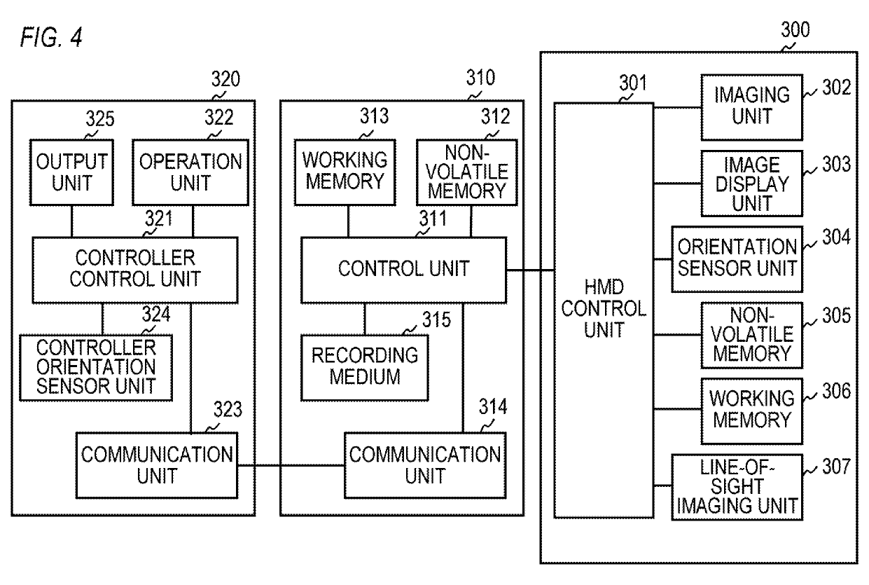

An example of a configuration of the HMD 300 will be described with reference to FIG. 4. The HMD 300 includes an HMD control unit 301, an imaging unit 302, an image display unit 303, an orientation sensor unit 304, a non-volatile memory 305, a working memory 306, and a line-of-sight imaging unit 307.

The HMD control unit 301 is a CPU that controls each component of the HMD 300. When acquiring a composite image (an image obtained by combining a captured image obtained by imaging the space in front of the user by the imaging unit 302 and the CG) from the PC 310, the HMD control unit 301 displays the composite image on the image display unit 303. Note that instead of the HMD control unit 301 controlling the entire device, a plurality of pieces of hardware may share processing to control the entire device.

The imaging unit 302 includes two cameras (imaging devices). The two cameras are for capturing a captured image used for combining with an image of a virtual space and generating position and orientation information, and include an imaging unit for the left eye and an imaging unit for the right eye. The imaging unit for the left eye captures a moving image of a real space corresponding to the left eye of the wearer of the HMD 300, and an image (captured image) of each frame in the moving image is output from the imaging unit for the left eye. The imaging unit for the right eye captures a moving image of a real space corresponding to the right eye of the wearer of the HMD 300, and an image (captured image) of each frame in the moving image is output from the imaging unit for the right eye. That is, the imaging unit 302 acquires a captured image as a stereo image having parallax substantially matched with the positions of the left eye and the right eye of the wearer of the HMD 300. Furthermore, information on the distance from the two cameras to an object can be acquired as distance information by distance measurement using the stereo camera. Note that, in the HMD for the MR system, it is preferable that the central optical axis of the imaging range of the imaging unit is arranged to substantially coincide with the line-of-sight direction of the wearer of the HMD.

Each of the imaging unit for the left eye and the imaging unit for the right eye includes an optical system and an imaging device. The light incident from the outside enters the imaging device through the optical system, and the imaging device outputs an image corresponding to the incident light as a captured image. Images of an object (a range in front of the user) captured by the two cameras are output to the PC 310 and the HMD control unit 301. Note that the imaging unit 302 may output a video instead of the captured image.

The image display unit 303 displays the composite image. The image display unit 303 includes a liquid crystal panel, an organic EL panel, or the like. In a state where the user wears the HMD 300, the image display unit 303 is arranged in front of each eye of the user. Note that a device using a semi-transmissive half mirror can also be used for the image display unit 303. In this case, for example, the image display unit 303 may display an image such that the CG is seen to be directly superimposed on the real space seen through the half mirror by a technique generally called augmented reality (AR). Furthermore, the image display unit 303 may display an image of a complete virtual space without using a captured image by a technology generally called virtual reality (VR).

The orientation sensor unit 304 acquires orientation (and position) information of the HMD 300. Note that the orientation sensor unit 304 may acquire orientation information of the user (the user wearing the HMD 300) corresponding to the orientation (and position) of the HMD300. For example, the orientation sensor unit 304 includes an inertial measurement unit (IMU) configured with an acceleration sensor, an angular acceleration sensor, and a geomagnetic sensor. The orientation sensor unit 304 is used to acquire information (orientation information) on the orientation of the user, and the HMD control unit 301 outputs the information (orientation information) on the orientation of the user to the PC 310. Note that the orientation information may be acquired from any one or more of a magnetic sensor (including a geomagnetic sensor), an ultrasonic sensor, an acceleration sensor, and an angular velocity sensor.

The HMD control unit 301 estimates the position or orientation of each joint point of the hand and the finger of the user on the basis of the images obtained by the two cameras of the imaging unit 302. Note that the joint points include points that are characteristic of parts such as a joint of a finger, a fingertip, a back of a hand (palm), and an arm. Each joint point indicates a coordinate position. The orientation of the hand can be estimated on the basis of the information of the plurality of joint points. As a method of estimating the positions or orientations of the hand and each joint point of the hand, for example, a known method of object recognition or pose estimation of machine learning using a convolutional neural network can be used. Furthermore, the position information in the depth direction of each joint point of the hand can be obtained, for example, by calculating the distance from the imaging unit 302 to each joint point by triangulation by stereo matching using images obtained by two cameras of the imaging unit 302. The estimated coordinate information of each joint point of the hand is output from the HMD control unit 301 to the PC 310.

The non-volatile memory 305 is an electrically erasable/recordable non-volatile memory, and stores a program or the like to be described later executed by the control unit 311.

The working memory 306 is used as a buffer memory that temporarily holds image data captured by the imaging unit 302, an image display memory of the image display unit 303, a work region of the HMD control unit 301, and the like.

The line-of-sight imaging unit 307 is a camera that acquires an image for detecting the line of sight of the user. The line-of-sight imaging unit 307 is attached inside the HMD 300 in order to image the user's eye when the user wears the HMD 300. An image obtained by photographing the object (user's eye) by the camera is output to the control unit 311 of the PC 310 via the HMD control unit 301. The control unit 311 detects the line of sight of the user wearing the HMD 300 from the image captured by the line-of-sight imaging unit 307, and specifies a portion gazed by the user on the image display unit 303.

### Internal Configuration of PC

An internal configuration of PC 310 will be described with reference to FIG. 4. The PC 310 includes a control unit 311, a non-volatile memory 312, a working memory 313, a communication unit 314, and a recording medium 315.

The control unit 311 is a CPU that controls each unit of the PC 310 according to an input signal or a program to be described later. Instead of the control unit 311 controlling the entire PC 310, a plurality of pieces of hardware may share processing to control the entire PC 310. The control unit 311 receives the image (captured image) acquired by the imaging unit 302 and the orientation information acquired by the orientation sensor unit 304 from the HMD 300. The control unit 311 performs image processing of canceling aberrations in the optical system of the imaging unit 302 and the optical system of the image display unit 303 on the captured image. Then, the control unit 311 combines the captured image and an arbitrary CG to generate a composite image. The control unit 311 transmits the composite image to the HMD control unit 301 in the HMD 300.

The control unit 311 also obtains the number of controllers 320 included in the captured image. In addition, the control unit 311 executes processing for recognizing the attached position of each controller 320 using the information obtained via the communication unit 314. Then, the control unit 311 performs control to change the operation content for the input information of each controller 320 for each controller according to the recognition result.

Note that the control unit 311 controls the position, orientation, and size of the CG in the composite image on the basis of the information (distance information and orientation information) acquired by the HMD 300. For example, in a case where the virtual object indicated by the CG is arranged near a specific object existing in the real space in the space indicated by the composite image, the control unit 311 increases the virtual object (CG) as the distance between the specific object and the imaging unit 302 is shorter. As described above, by controlling the position, orientation, and size of the CG, the control unit 311 can generate a composite image as if a CG object not arranged in the real space is arranged in the real space.

Furthermore, the control unit 311 receives information estimated by the HMD control unit 301 of the HMD 300. The received information is temporarily stored in the working memory 313.

Furthermore, the control unit 311 receives change information of the position or orientation of the controller 320 from the communication unit 323 of the controller 320. The control unit 311 superimposes a display item indicating an instruction position according to the change information of the position or orientation of the controller 320 on the combined image. Note that the control unit 311 may superimpose a display item indicating an instruction position according to the change information of the position and orientation of the controller 320 on the combined image.

The non-volatile memory 312 is an electrically erasable and recordable non-volatile memory. The non-volatile memory 312 stores a program to be described later executed by the control unit 311 and information such as CG. Note that the control unit 311 can switch computer graphics (that is, the CG used for generating the composite image) read from the non-volatile memory 312.

The working memory 313 is used as a buffer memory that temporarily holds image data imaged by the imaging unit 302 and estimated time series information of the coordinate position of each joint point of the hand. The working memory 313 is used as an image display memory of the image display unit 303, a work region of the control unit 311, and the like.

In addition, the hand joint may be estimated by the PC 310. In this case, after the captured image is output from the imaging unit 302 to the PC 310, the control unit 311 of the PC 310 estimates the position or orientation of each joint point of the hand. Then, the control unit 311 uses the information to process the image and outputs the processed image to the HMD 300. Note that the control unit 311 may estimate the position and orientation of each joint point of the hand, process the image using the information, and output the processed image to the HMD 300.

### Internal Configuration of Controller

An internal configuration of the controller 320 will be described with reference to FIG. 4. The controller 320 includes a controller control unit 321, an operation unit 322, a communication unit 323, a controller orientation sensor unit 324, and an output unit 325.

The controller control unit 321 is a CPU that controls each component of the controller 320. Note that instead of the controller control unit 321 controlling the entire controller 320, a plurality of pieces of hardware may share processing to control the entire controller 320.

The operation unit 322 includes a button. The operation unit 322 detects whether or not the button has been operated, and transmits detection information to the PC 310 via the communication unit 323. Note that the operation unit 322 may have a plurality of types of input formats.

The communication unit 323 performs wireless communication by Bluetooth with the PC 310. When the plurality of controllers 320 are connected to the PC 310, the communication unit 323 of each of the plurality of controllers 320 performs wireless communication by Bluetooth with the PC 310.

The controller orientation sensor unit 324 has an inertial measurement unit (IMU) including an acceleration sensor, an angular acceleration sensor, and a geomagnetic sensor. The inertial measurement unit detects a change in position or orientation of the controller 320. The detected change information in the position and orientation is communicated from the communication unit 323 to the PC 310 via the controller control unit 321.

The output unit 325 includes a light source of an LED, a speaker, a vibration element, and the like.

### Example of MR Space

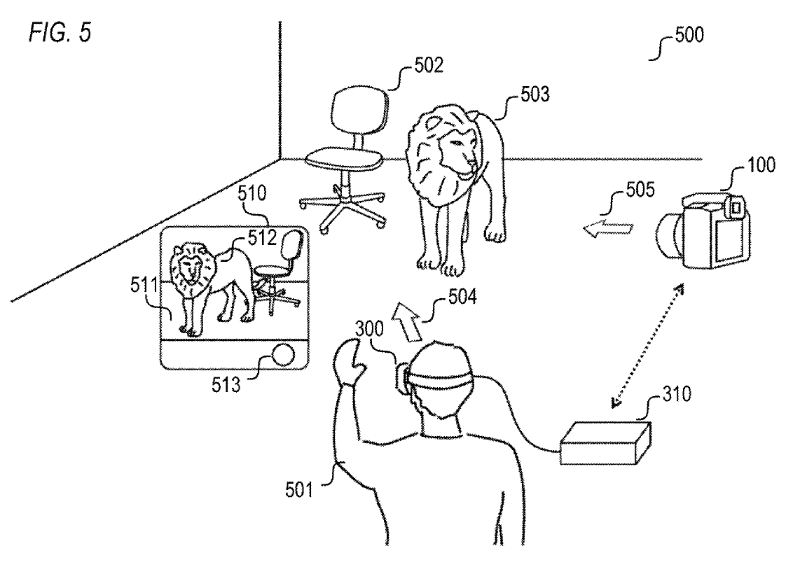

An example of an MR space experienced by the user wearing the HMD 300 in the first embodiment will be described with reference to FIG. 5. In the MR space 500, there are a user 501, an HMD 300 worn by the user 501, a PC 310 communicating with the HMD 300, and a camera 100 communicating with the PC 310. In addition, there are a real object 502, a virtual object 503, and a virtual window 510 in the MR space 500.

The virtual window 510 is an example of a UI of a photographing application. In the virtual window 510, a live view image 511, a virtual object 512, and an operation member 513 are displayed. The live view image 511 is an image acquired by imaging by the imaging unit 211 of the camera 100. The virtual object 512 is a virtual object in a form corresponding to the position and orientation of the camera 100.

Furthermore, an arrow 504 indicates a direction in which the imaging unit 302 of the HMD 300 worn by the user 501 captures an image. An arrow 505 indicates a direction in which the imaging unit 211 of the camera 100 captures an image.

### Image Display Example of HMD 300

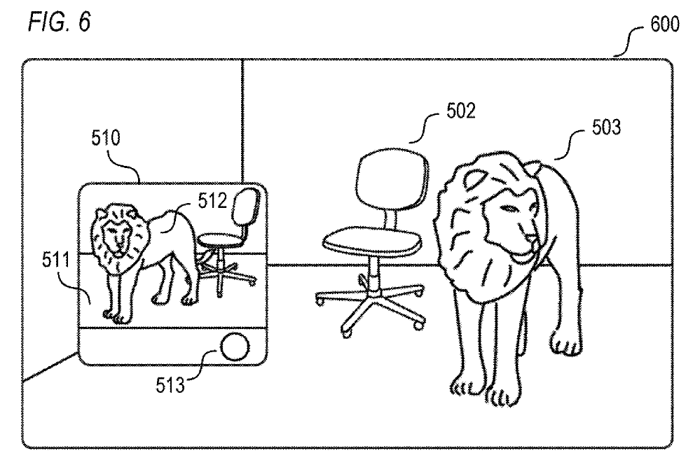

An example of display on the image display unit 303 of the HMD 300 will be described with reference to FIG. 6. A screen 600 in FIG. 6 illustrates an example of display of the image display unit 303 in a case where the imaging unit 302 of the HMD 300 worn by the user 501 captures an image of a range in the direction of the arrow 504 in FIG. 5.

A real object 502, a virtual object 503, and a virtual window 510 are displayed on the screen 600. In the virtual window 510, a live view image 511, a virtual object 512, and an operation member 513 are displayed.

Note that the position and orientation of the virtual object 503 and the virtual window 510 are adjusted to a position and orientation corresponding to a case where the imaging unit 302 captures an image of the range in the direction of the arrow 504 in FIG. 5. The orientation of the virtual object 512 displayed in the virtual window 510 is adjusted to a position and orientation corresponding to a case where the imaging unit 211 of the camera 100 captures an image of the range in the direction of the arrow 505 in FIG. 5. Note that an example in which the virtual window 510 is arranged as if it virtually exists at an arbitrary three-dimensional position and orientation in the space as illustrated in the MR space 500 of FIG. 5 will be described, but the present disclosure is not limited thereto. The virtual window 510 may be arranged at any two-dimensional position in the display region of the screen 600.

### Live View Processing of Camera 100

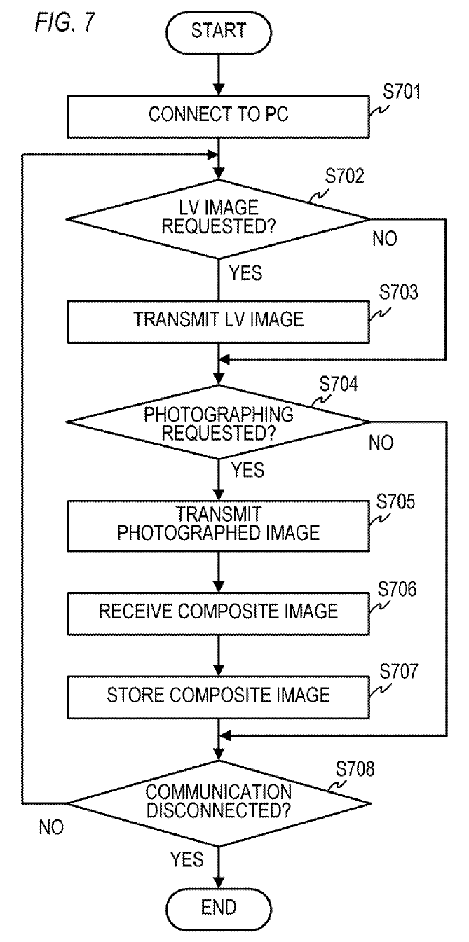

The processing of the camera 100 in the first embodiment will be described with reference to the flowchart in FIG. 7.

In step S701, the system control unit 50 controls the communication unit 221 to connect the camera and the PC 310 so as to enable communication. The type of the connection method with the PC 310 is not limited. The connection with the PC 310 may be realized by either wireless communication or wired communication.

In step S702, the system control unit 50 determines whether or not acquisition of a live view image (LV image; real-time image) has been requested from the PC 310. In a case where it is determined that acquisition of a live view image has been requested, the process proceeds to step S703. In a case where it is determined that acquisition of a live view image has not been requested, the process proceeds to step S704.

In step S703, the system control unit 50 transmits the live view image (live view information) to the PC 310 so as to reply to the request for acquiring the live view image. In addition, the system control unit 50 transmits lens optical information in addition to the live view image information.

In step S704, the system control unit 50 determines whether or not photographing has been requested (photographing from the PC 310 has been requested, or photographing has been requested by the user operating the camera 100). In a case where it is determined that photographing has been requested, the process proceeds to step S705. In a case where it is determined that photographing has not been requested, the process proceeds to step S708.

In step S705, the system control unit 50 executes photographing processing. The system control unit 50 transmits the image (photographed image) acquired by the photographing processing to the HMD 300.

In step S706, the system control unit 50 receives the composite image generated by the HMD 300.

In step S707, the system control unit 50 stores the composite image received in step 706 in the recording medium 227.

In step S708, the system control unit 50 determines whether or not communication with the PC 310 is disconnected. In a case where it is determined that the communication with the PC 310 is disconnected, the processing of this flowchart ends. In a case where it is determined that the communication with the PC 310 is not disconnected, the process proceeds to step S702.

### Live View Processing

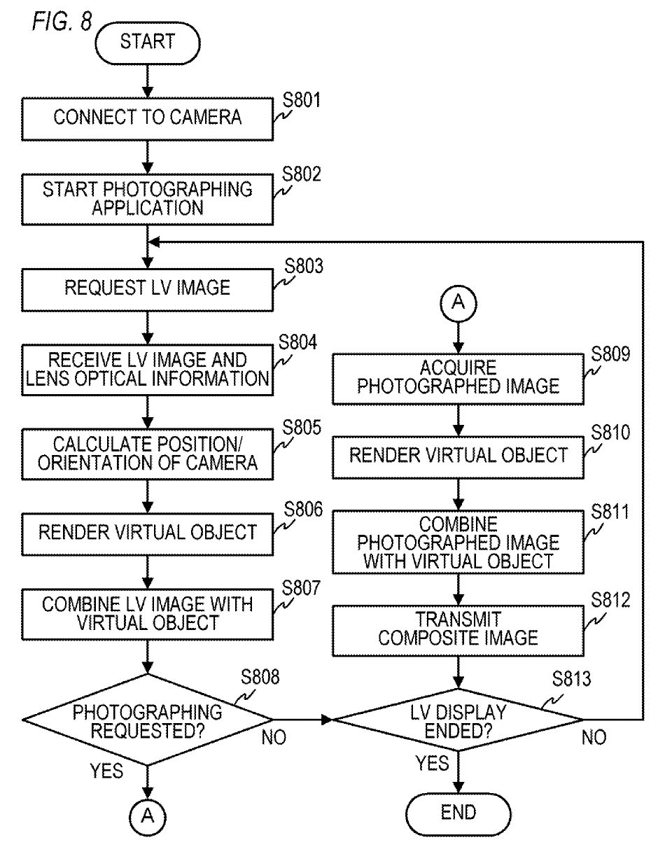

Live view processing by the PC 310 according to the first embodiment will be described with reference to the flowchart of FIG. 8. Note that the HMD 300 (HMD control unit 301) may execute all or a part of the processing of this flowchart instead of the PC 310.

In step S801, the control unit 311 controls the communication unit 314 to connect the camera 100 and the PC so as to enable communication.

In step S802, the control unit 311 starts the photographing application. A user interface (UI) of the started photographing application is displayed on the image display unit 303.

In step S803, the control unit 311 requests the camera 100 to acquire a live view image.

In step S804, the control unit 311 receives the live view image and the lens optical information from the camera 100.

In step S805, the control unit 311 calculates the position and orientation (position and orientation information) of the camera 100 on the basis of the live view image and the lens optical information. For example, simultaneous localization and mapping (SLAM) can be used to calculate the position and orientation.

In step S806, the control unit 311 renders the object on the virtual space displayed by the HMD 300 so as to be an object as viewed from the camera 100 on the basis of the position and orientation of the camera 100.

In step S807, the control unit 311 combines the object in the virtual space displayed on the HMD 300 with the live view image on the basis of the result of rendering in step S806. As a result, the control unit 311 generates the LV composite image. Then, the control unit 311 draws the LV composite image in the window of the photographing application.

In step S808, the control unit 311 determines whether or not photographing has been requested (photographing has been requested by the user operating the photographing application, or photographing has been requested by the user operating the camera 100). In a case where it is determined that photographing has been requested, the process proceeds to step S809. In a case where it is determined that photographing has not been requested, the process proceeds to step S813.

In step S809, the control unit 311 receives the photographed image from the camera 100.

In step S810, the control unit 311 renders the object on the virtual space displayed by the HMD 300 so as to be an object as viewed from the camera 100 on the basis of the position and orientation of the camera 100.

In step S811, the control unit 311 combines the object on the virtual space displayed by the HMD 300 with the photographed image on the basis of the result of rendering in step S810. As a result, the control unit 311 generates a composite image.

In step S812, the control unit 311 transmits the composite image generated in step S811 to the camera 100.

In step S813, the control unit 311 determines whether or not to end the live view display (display of the live view image). In a case where it is determined to end the live view display, the processing of this flowchart ends. In a case where it is determined not to end the live view display, the process proceeds to step S803.

### UI Display Processing

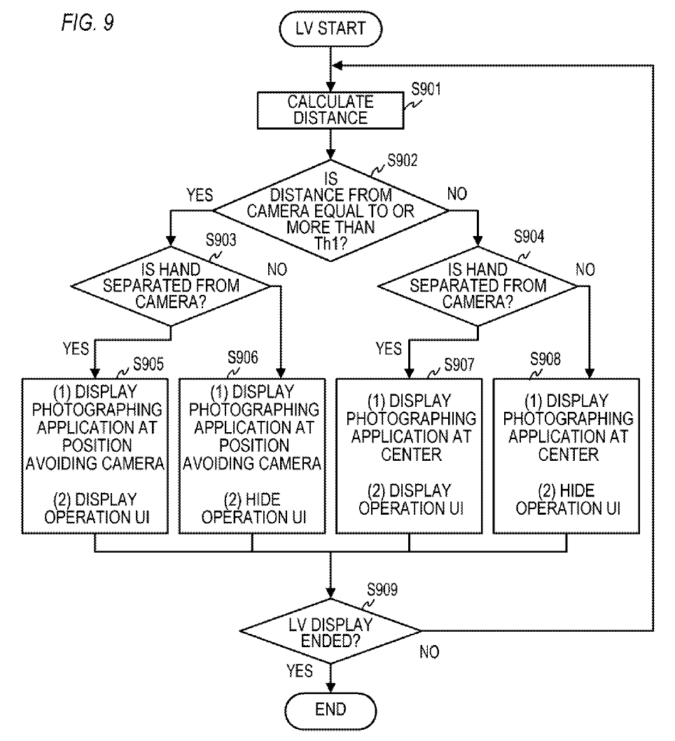

UI display processing during live view by the PC 310 according to the first embodiment will be described with reference to a flowchart of FIG. 9. Note that the HMD 300 (HMD control unit 301) may execute all or a part of the processing of this flowchart instead of the PC 310.

In step S901, the control unit 311 calculates the distance between the HMD 300 (= the head of the user) and the camera 100 on the basis of the image acquired by the imaging unit 302 (the image obtained by imaging the space from the user's viewpoint). For example, the control unit 311 calculates the SLAM on the basis of the image to calculate the position and orientation of the HMD 300. Then, the control unit 311 calculates the distance between the HMD 300 and the camera 100 on the basis of the position and orientation of the HMD 300 and the position and orientation of the camera 100 calculated in step S805.

In step S902, the control unit 311 determines whether or not the distance between the camera 100 and the HMD 300 (= the head of the user) is equal to or more than a threshold Th1. In a case where it is determined that the distance between the camera 100 and the HMD 300 is equal to or more than the threshold Th1, the process proceeds to step S903. In a case where it is determined that the distance between the camera 100 and the HMD 300 is less than the threshold Th1, the process proceeds to step S904.

In step S903, the control unit 311 determines whether or not the user's hand is separated from the camera 100 (alternatively, the distance between the user's hand and the camera 100 is less than a specific value) on the basis of the image acquired by the imaging unit 302. In a case where it is determined that the user's hand is separated from the camera 100, the process proceeds to step S905. In a case where it is determined that the user's hand is not separated from the camera 100, the process proceeds to step S906.

In step S904, the control unit 311 determines whether or not the user's hand is separated from the camera 100 on the basis of the image acquired by the imaging unit 302. In a case where it is determined that the user's hand is separated from the camera 100, the process proceeds to step S907. In a case where it is determined that the user's hand is not separated from the camera 100, the process proceeds to step S908.

In each of the following steps S905 to S908, processing of generating a composite image obtained by combining one image and the photographing application 1201 (image captured by the camera 100) and displaying the composite image on the image display unit 303 is performed.

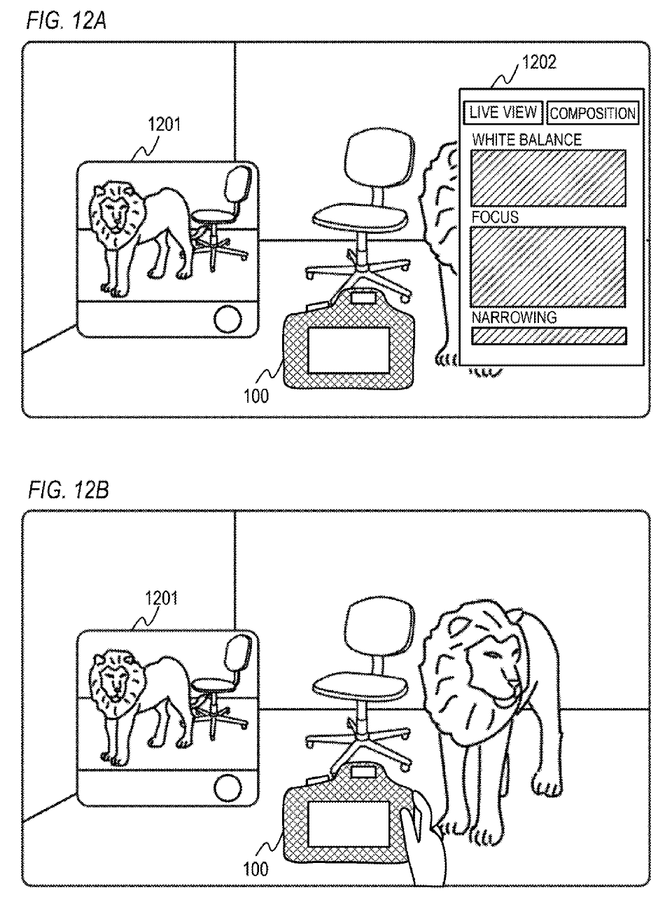

In step S905, as illustrated in FIG. 12A, the control unit 311 generates a composite image in which the photographing application 1201 is arranged at a position not overlapping with the camera 100 in the image obtained by imaging the MR space from the user's viewpoint (viewpoint of the HMD 300). Furthermore, at this time, the control unit 311 arranges the operation UI 1202 for controlling the setting (photographing setting) of the camera 100 in the composite image (sets the operation UI 1202 to the display state). Then, the control unit 311 displays the composite image on the image display unit 303.

In step S906, as illustrated in FIG. 12B, the control unit 311 generates a composite image in which the photographing application 1201 is arranged at a position not overlapping with the camera 100 in the image obtained by imaging the MR space from the user's viewpoint. Furthermore, at this time, the control unit 311 does not arrange the operation UI 1202 in the composite image (sets the operation UI 1202 to the non-display state). Then, the control unit 311 displays the composite image on the image display unit 303.

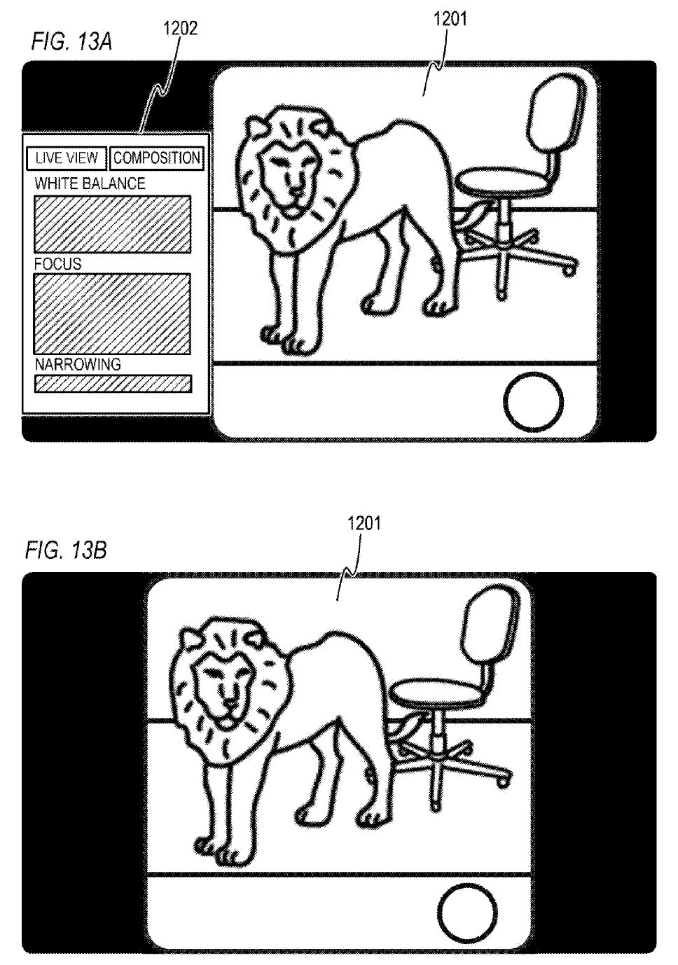

In step S907, as illustrated in FIG. 13A, the control unit 311 generates a composite image in which the photographing application 1201 is arranged in the central portion (the center of the visual field of the HMD 300) of the background image (composite image) and the UI other than the photographing application 1201 is hidden. Furthermore, the control unit 311 arranges the operation UI 1202 of the photographing application in the composite image (sets the operation UI 1202 to the display state). Then, the control unit 311 displays the composite image on the image display unit 303. Furthermore, the background image may be an image obtained by imaging the MR space from the user's viewpoint, or may be a black image (black image). Instead of blacking the background image, the control unit 311 may use an image obtained by performing at least defocus, monochrome, and luminance reduction processing on the image acquired by the imaging unit 302. At this time, the control unit 311 may arrange the photographing application 1201 at a position, not limited to the accurate central portion of the background image (composite image), but closer to the center in the image display unit 303 (composite image) as compared with the case of steps S905 and S906. The control unit 311 may display (arrange) the photographing application 1201 larger than the case of steps S905 and S906 so that the user can easily confirm the photographing application 1201.

In step S908, as illustrated in FIG. 13B, the control unit 311 generates a composite image in which the photographing application 1201 is arranged in the central portion (the center of the visual field of the HMD 300) of the background image (composite image) and the UI other than the photographing application 1201 is hidden. Furthermore, the control unit 311 does not arrange the operation UI 1202 of the photographing application in the composite image (sets the operation UI 1202 to the non-display state). At this time, the control unit 311 may arrange the photographing application 1201 at a position, not limited to the accurate central portion of the background image (composite image), but closer to the center in the image display unit 303 (composite image) as compared with the case of steps S905 and S906. The control unit 311 may display (arrange) the photographing application 1201 larger than the case of steps S905 and S906. Furthermore, the background image may be an image obtained by imaging the MR space from the user's viewpoint, or may be a black image (black image).

In step S909, the control unit 311 determines whether or not to end the live view display (LV display). In a case where it is determined to end the live view display, the processing of this flowchart ends. In a case where it is determined not to end the live view display, the process proceeds to step S901.

In this manner, the position at which the photographing application 1201 is displayed is switched according to the distance between the camera 100 and the HMD 300. Specifically, in a case where the distance between the camera 100 and the HMD 300 is short, the ratio occupied by the camera 100 in the image obtained by imaging the MR space from the user's viewpoint increases, and the necessity of viewing the image decreases. Therefore, in such a case, it can be assumed that the user wants to refer to the photographing application 1201, and thus, the photographing application 1201 is arranged at the center of the composite image. On the other hand, in a case where the distance between the camera 100 and the HMD 300 is long, the ratio occupied by the camera 100 in the image obtained by imaging the MR space from the user's viewpoint is small, and there is a high possibility that the user wants to view the image. Therefore, in such a case, the photographing application 1201 is arranged at a position not overlapping with the camera 100 which is an important element in the image.

For example, in a case where the user performs photographing while holding the imaging device in a state where the HMD is worn, a style in which the user holds the imaging device with both hands and looks into a finder may be adopted. This style has advantages that “photographing can be performed at substantially the same position as one's eye line” and “photographing can be stably performed by firmly holding the camera with the sides closed”. Therefore, it is considered that the photographing style is useful even in a state where the HMD goggles are worn. However, when such a style is adopted, since the imaging device occupies most of the image displayed on the HMD, the user who has viewed the image cannot intensively perform photographing. In view of such a problem, according to the present embodiment, it is possible to generate an image that allows the user to concentrate on photographing in a case where photographing processing is performed while confirming a live view image acquired by the camera 100 using the HMD 300.

### Second Embodiment

Hereinafter, a second embodiment will be described. In the second embodiment, the distance between the camera 100 and the HMD 300 is estimated using the value of the eyepiece sensor of the camera 100.

### Live View Processing of Camera 100

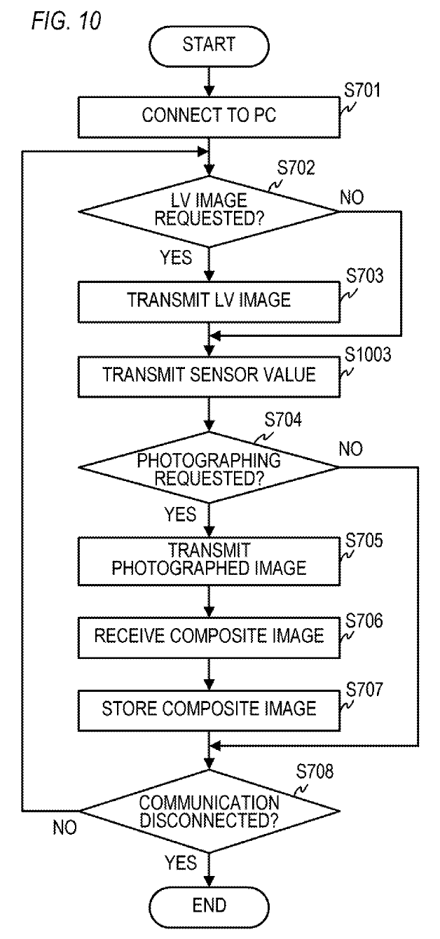

Processing of the camera 100 in the second embodiment will be described with reference to a flowchart in FIG. 10.

Steps S701 to S703 are the same as those in the first embodiment, and thus description thereof is omitted.

In step S1003, the system control unit 50 acquires the sensor value from the eyepiece detection unit 118 (eyepiece sensor) and transmits the sensor value to the HMD 300. The sensor value takes a smaller value as the distance between the camera 100 and the HMD 300 is larger.

Steps S704 to S708 are the same as those in the first embodiment, and thus description thereof is omitted.

### UI Display Processing

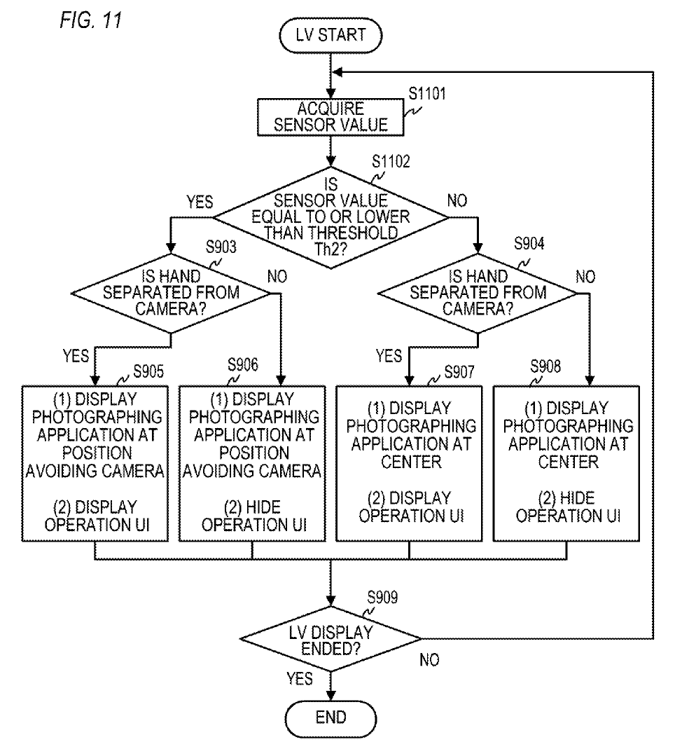

Processing during live view in the second embodiment will be described with reference to a flowchart in FIG. 11.

In step S1101, the control unit 311 acquires the sensor value acquired by the eyepiece detection unit 118 from the camera 100.

In step S1102, the control unit 311 determines whether or not the sensor value acquired in step S1102 is equal to or less than a threshold Th2. In a case where it is determined that the sensor value is equal to or less than the threshold Th2 (equal to or less than a specific threshold), it is determined that the distance between the camera 100 and the HMD 300 is equal to or more than a threshold TH1, and the process proceeds to step S903. In a case where it is determined that the sensor value is not equal to or less than the threshold Th2, it is determined that the distance between the camera 100 and the HMD 300 is larger than the threshold TH1, and the process proceeds to step S904.

Steps S903 to S909 are the same as those in the first embodiment, and thus description thereof is omitted.

Note that, in the second embodiment, the control unit 311 acquires the sensor value acquired by the eyepiece detection unit 118 by communication, and acquires information on the distance between the camera 100 and the HMD 300 (= the head of the user) according to the sensor value. However, the control unit 311 may acquire information on the distance between the camera 100 and the HMD 300 by another method. For example, the control unit 311 may acquire information on the distance between the camera 100 and the HMD 300 on the basis of a sensor value of a distance sensor provided in the HMD 300. For example, the control unit 311 may acquire an image obtained by imaging the HMD 300 by the camera 100 by communication, and acquire information on the distance between the camera 100 and the HMD 300 on the basis of the acquired image. Alternatively, in a case where the camera 100 and the HMD 300 perform wireless communication with each other, the control unit 311 may acquire (estimate) information on the distance between the camera 100 and the HMD 300 on the basis of the communication strength of the wireless communication. Furthermore, the control unit 311 may acquire information on the distance between the camera 100 and the HMD 300 from the camera 100 by communication.

In addition, in the above description, “in a case where A is B or more, the processing proceeds to step S1, and in a case where A is smaller (lower) than B, the processing proceeds to step S2” may be read as “in a case where A is larger (higher) than B, the processing proceeds to step S1, and in a case where A is equal to or smaller than B, the processing proceeds to step S2”. Conversely, “in a case where A is larger (higher) than B, the processing proceeds to step S1, and in a case where A is B or less, the processing proceeds to step S2” may be read as “in a case where A is B or more, the processing proceeds to step S1, and in a case where A is smaller (lower) than B, the processing proceeds to step S2”. For this reason, unless there is a contradiction, “A or more” may be read as “larger (higher; longer; more) than A”, and “A or less” may be read as “smaller (lower; shorter; less) than A". Moreover, “larger (higher; longer; more) than A” may be read as “A or more”, and “smaller (lower; shorter; less) than A” may be read as “A or less”.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present disclosure are also included in the present disclosure. The present disclosure also includes other configurations obtained by suitably combining various features of the embodiment.

According to the present disclosure, in a case of photographing a specific space by an imaging device, it is possible to generate an image that assists a user so that photographing can be performed in a concentrated manner.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD) ^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-216324, filed December 11, 2024, which is hereby incorporated by reference herein in its entirety.

What is claimed is:

1. An information processing device communicably connected to an imaging device, the information processing device comprising:
a processor; and
a memory storing a program which, when executed by the processor, causes the information processing device to:
execute first acquisition processing of acquiring a first image in which a space is imaged according to a viewpoint of a user;
execute second acquisition processing of acquiring a second image in which the space is imaged by the imaging device; and
execute generation processing of generating a composite image in which the second image and a third image are combined with each other,
wherein in a first case where a distance between a head of the user and the imaging device is larger than a threshold, the third image is the first image, and
wherein in the generation processing, in a second case where the distance between the head of the user and the imaging device is equal to or less than the threshold, the second image is arranged closer to a center of the composite image than in the first case.

2. The information processing device according to claim 1, wherein in the generation processing, in a case where it is determined that a hand of the user is separated from the imaging device, an operation user interface for controlling a setting of the imaging device is arranged in the composite image.

3. The information processing device according to claim 2, wherein the program, when executed by the processor, causes the information processing device to execute determination processing of determining whether or not the hand of the user is separated from the imaging device on a basis of the first image.

4. The information processing device according to claim 1, wherein the second image includes a real-time image acquired from the imaging device.

5. The information processing device according to claim 1, wherein the imaging device is controlled on a basis of an instruction of the user.

6. The information processing device according to claim 1, wherein the program, when executed by the processor, further causes the information processing device to execute acquisition processing of acquiring information on the distance between the head of the user and the imaging device.

7. The information processing device according to claim 6, wherein in the acquisition processing, the information on the distance between the head of the user and the imaging device is acquired on a basis of the first image.

8. The information processing device according to claim 6, wherein in the acquisition processing, the information on the distance between the head of the user and the imaging device is acquired on a basis of a value of an eyepiece sensor of the imaging device.

9. The information processing device according to claim 6, wherein in the acquisition processing, the information on the distance between the head of the user and the imaging device is acquired by communication from the imaging device.

10. The information processing device according to claim 1, wherein in the second case, the third image is a black image.

11. The information processing device according to claim 1, wherein in the generation processing, in the second case, the composite image is generated by using an image obtained by performing at least one of defocus, monochrome, and luminance reduction processing on the first image as the third image.

12. The information processing device according to claim 1, wherein in the generation processing, in the first case, the second image is arranged at a position not overlapping with the imaging device in the first image.

13. A control method for an information processing device communicably connected to an imaging device, the control method comprising:
acquiring a first image in which a space is imaged according to a viewpoint of a user;
acquiring a second image in which the space is imaged by the imaging device; and
generating a composite image in which the second image and a third image are combined with each other,
wherein in a first case where a distance between a head of the user and the imaging device is larger than a threshold, the third image is the first image, and
wherein in the generation processing, in a second case where the distance between the head of the user and the imaging device is equal to or less than the threshold, the second image is arranged closer to a center of the composite image than in the first case.

14. A non-transitory computer readable medium that stores a program, wherein the program causes a computer to execute a control method for an information processing device communicably connected to an imaging device, the control method comprising:
acquiring a first image in which a space is imaged according to a viewpoint of a user;
acquiring a second image in which the space is imaged by the imaging device; and
generating a composite image in which the second image and a third image are combined with each other,
wherein in a first case where a distance between a head of the user and the imaging device is larger than a threshold, the third image is the first image, and
wherein in the generation processing, in a second case where the distance between the head of the user and the imaging device is equal to or less than the threshold, the second image is arranged closer to a center of the composite image than in the first case.
